(19) United States
(12) Patent Application Publication
(10) Pub. No.: US 2010/0057768 A1
(43) Pub. Date: Mar. 4, 2010

(54) Electronic apparatus capable of automatic tag generation, tag generation method and tag generation system

(75) Inventors: Jie-Min CHEN, Taipei City (TW); Kai-Wen TIEN, Tainan City (TW); Ming-Chuan HU, Taipei County (TW)

Correspondence Address: REED SMITH LLP, Suite 1400, 3110 Fairview Park Drive, Falls Church, VA, 22042, US

(73) Assignee: Quanta Computer Inc.

(21) Appl. No.: 12/285,995

(22) Filed: Oct. 17, 2008

(30) Foreign Application Priority Data
Sep. 4, 2008 (TW) 097112815

(51) Int. Cl. G06F 17/30

(52) U.S. Cl. 707/102; 707/E17.005

(57) ABSTRACT

The invention provides an electronic apparatus capable of automatically generating tags which can generate an applicable tag related to a digital content. The electronic apparatus includes a storage module, a communication module and a processing module. The storage module therein stores a set of initial data related to the digital content. The communication module is used for communicating with a social network which can provide a shared tag. The processing module is coupled with the storage module and the communication module. The processing module receives the shared tag via the communication module and generates the applicable tag according to the set of initial data and the shared tag.

### BACKGROUND OF THE INVENTION

1. Field of the invention

This invention relates to an electronic apparatus, a tag generation method, and a tag generation system which are capable of automatically generating tags, and more particularly, to an electronic apparatus, a tag generation method and a tag generation system which shared tags via a social network.

2. Description of the prior art

In web2.0, a tag is an important element. A tag usually represents a keyword or a term used to be associated or to classify a kind of digital content (such as articles, images, photos, videos, audios, or animations) or a kind of online resource (such as computer files, web pages, or internet bookmark), which makes the follow-up arrangements and searches convenient. In additional, the tag can be presented in a form of image. The image is a collection of letter tags, which collects many letter tags to be a meaningful representation.

In practice, a tag is usually provided by the author of a digital content when the digital content is generated. For example, when a blog is accomplished, the author will give or assign the blog one or a plurality of tags according to its content. For instance, when the author “A” accomplish a blog about shopping in the Taipei 101, one or a plurality of tags can be assigned to the blog, such as “101”, “shopping”, “department store”, etc.

Or, when users “B” wants to upload a set of photos about seeing sunrise on the A-Li mountain to a photo sharing website, one or a plurality of tags can also be assigned to the set of photos, such as “A-Li mountain”, “sunrise”, “hiking”, etc. Even an image of the sunrise can be uploaded to be a tag.

Generally, the way of giving the tags usually requires users to input the tag by themselves. However, while giving the tag related to the digital content, users usually need to execute inputting actions through the input module of an electronic apparatus. If the electronic apparatus which is used to generate digital contents belongs to a portable electronic apparatus, such as a digital camera, the input module is usually inconvenient for users to input due to the design of size (for example, no keyboard embedded in the digital camera), which further makes users distracted.

Accordingly, the major scope of the inventor is to provide an electronic apparatus, a tag generation method, and a tag generation system which are capable of automatically generating tags to solve the foregoing problems.

### SUMMARY OF THE INVENTION

A scope of the invention is to provide an electronic apparatus, a tag generation method, and a tag generation system which are capable of automatically generating tags. The electronic apparatus, the tag generation method, and the tag generation system automatically generate an applicable tag related to a digital content by a shared tag provided by a social network and a set of initial data. Thereby, users can selectively assign the applicable tags, which are automatically generated, to the digital content without inputting tags by themselves.

According to the embodiment of the invention, the electronic apparatus, capable of automatically generating tags, is used to generate an applicable tag related to a digital content. The electronic apparatus includes a storage module, a communication module, and a processing module. The storage module therein stores a set of initial data related to the digital content. The communication module is used for communicating with a social network based on a protocol. The social network provides a shared tag. The processing module is coupled to the storage module and the protocol module. The processing module is used for receiving the shared tag via the communication module and generating the applicable tag according to the set of initial data and the shared tag.

According to another embodiment of the invention, the tag generation method is used for generating an applicable tag related to a digital content. At first, the tag generation method is performed to communicate with a social network based on a protocol, wherein the social network provides a shared tag. Next, the tag generation method is performed to receive the shared tag. Finally, the tag generation method is performed to generate the applicable tag according to the set of initial data and the shared tag.

According to another embodiment of the invention, the tag generation is used for generating an applicable tag related to a digital content. The tag generation system includes a receiving module, a tag database and a control module. The receiving module is used for receiving a set of initial data related to the digital content. The control module is coupled to the receiving module and the tag database. The control module is used for generating the applicable tag according to the set of initial data and the tag database.

The advantage and spirit of the invention may be understood by the following recitations together with the appended drawings.

### BRIEF DESCRIPTION OF THE APPENDED DRAWINGS

FIG. 1 is a schematic diagram illustrating an electronic apparatus capable of automatically generating tags according to an embodiment of the invention.

FIG. 2 is a schematic diagram illustrating an example of the set of initial data in FIG. 1.

FIG. 3 is a schematic diagram illustrating the social network in FIG. 1 from nearest to farthest.

FIG. 4 is a flow chart diagram showing a tag generation method according to an embodiment of the invention.

FIG. 5 is a schematic diagram illustrating a tag generation system according to an embodiment of the invention.

### DETAILED DESCRIPTION OF THE INVENTION

The invention is to provide an electronic apparatus, a tag generation method, and a tag generation system which are capable of automatically generating tags. The electronic apparatus, the tag generation method, and the tag generation system automatically generate an applicable tag related to a digital content by a shared tag and a set of initial data provided by a social network. Thereby, users can selectively assign the applicable tags, which are automatically generated, to the digital content without inputting tags by themselves. With the embodiment of the invention below, the features and spirits of the invention will be hopefully well described.

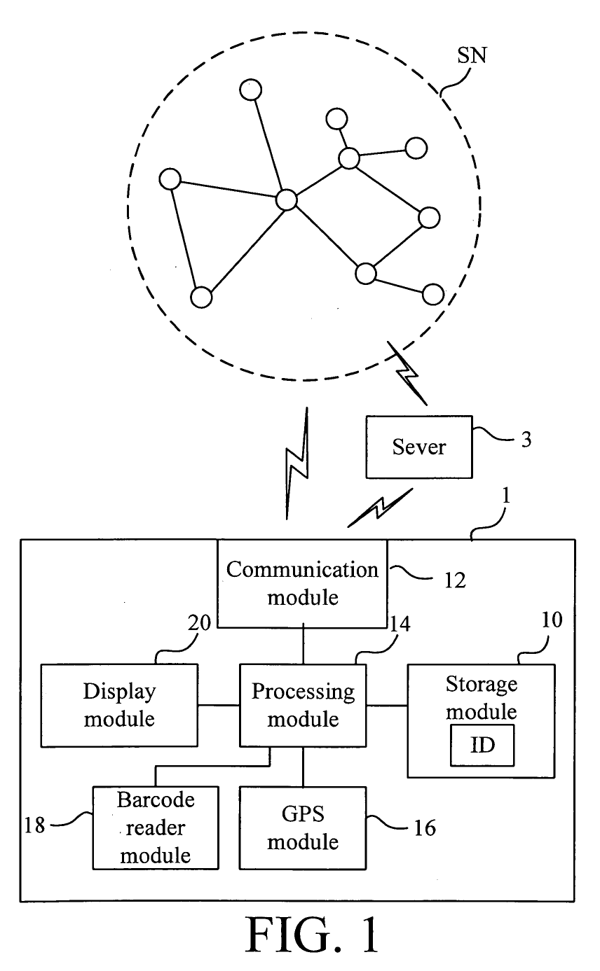

Please refer to FIG. 1. FIG. 1 is a schematic diagram illustrating an electronic apparatus 1 capable of automatically generating tags according to an embodiment of the invention. In a practical application, the electronic apparatus 1 can be, but not limited to, a digital camera, a digital video recorder, a digital audio recorder, etc.

In the embodiment, the electronic apparatus 1 can be used to generate an applicable tag related to a digital content. In a practical application, the digital content can be articles, images, photos, videos, audios, or animations, or a kind of online resource, such as computer files, web pages, internet bookmark, etc. For example, the electronic apparatus 1 can be a digital camera, and the digital content can be a photo taken by the electronic apparatus 1 (i.e. the digital camera). Or, the electronic apparatus 1 can be a digital video recorder, and the digital content can be a video recorded by the electronic 1 (i.e. the digital video recorder).

In an embodiment, the electronic apparatus 1 includes a storage module 10, a communication module 12, and a processing module 14. The connection relationships among the modules in the electronic apparatus 1 can be seen in FIG. 1. The processing module 14 is respectively coupled to the storage module 10 and the communication module 12.

In an embodiment, the storage module 10 can store a set of initial data ID related to the digital content. The communication 12 module can be used to communicate with a social network SN based on a protocol, wherein the social network SN can provide a shared tag. The processing module 14 can be used to receive the shared tag via the communication module 12 and generate the applicable tag according to the set of initial data ID and the shared tag.

In an embodiment, the set of initial data ID, related to the digital content, which is stored in the storage module 10 can include user preferences, apparatus information, location information, date information, time information, or action events, etc.

In a practical application, the user preferences can include various kinds of information about users, such as, but not limited to, name, sex, connubiality, family, friends, groups, company, birthday, aptitude, or hobby. The apparatus information can include, but not limited to, the name, the type, the characteristics, or the manufacturer of the electronic apparatus 1.

In a practical application, the location information can be induced by any ways. For example, the electronic apparatus 1 can further include a GPS (Global Position System) module 16 and obtain the location information by the GPS module 16. In addition, the electronic apparatus 1 can further include a barcode reader module 18 and read barcodes which contain location information with the barcode reader module 18 to get location information; or, the electronic apparatus 1 can have the ability of communicating with a plurality of base stations (not shown in FIG. 1) and determine the location information according to the signal intensities of communication of the base stations.

In a practical application, the action events can include any action events participated by users. The action events can be detected by the electronic apparatus 1 or transmitted to the electronic apparatus 1 from other apparatuses. For example, when a user takes pictures with the electronic apparatus 1 (e.g. a digital camera), the action event of pressing the camera shutter can be detected and derived from the electronic apparatus 1, so as to generate an applicable tag in accordance with the action event. Another example, when a user buys a ticket with a credit card (i.e. the credit card machine transmits the data to a remote server at the same time), the action event of buying the ticket can be detected by other related electronic apparatuses (such as the remote server) which then transmit the action event and the related information (such as the consuming location, the consuming contents, the place of buying the tickets etc.) to the electronic apparatus 1 with the communication module 12.

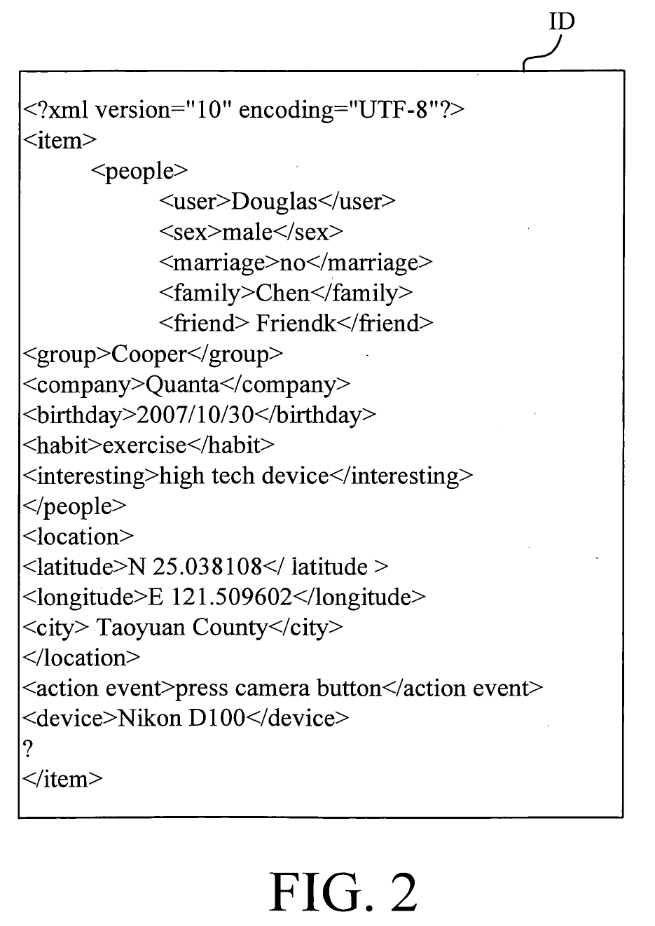

Please refer to FIG. 2. FIG. 2 is a schematic diagram illustrating an example of the set of initial data ID in FIG. 1. As shown in FIG. 2, in a practical application, the set of initial data ID can conform to, but not limited, an Extensible Markup Language, (XML) format.

In an embodiment, the protocol can be a wireless protocol, such as, but not limited to, Bluetooth protocol, Zigbee protocol, WiFi protocol, IEEE 802.15.4 protocol, IEEE 802.11 series protocols, RFID protocol, even includes two protocols listed above. In a practical application, the communication module 12 can form an ad hoc network based on the protocol, and build up the social network SN via the ad hoc network. In a practical application, in order to decrease the computing load of the electronic apparatus 1, the communication module 12 can connect to a sever 3, build up the social network SN with the sever 3, and receive the shared tag from the sever 3.

In an embodiment, the social network SN can be a location-based social network. For example, when a group of users go to an amusement park, the users can organize the social network SN. In a practical application, the tags generated by all users in the social network SN can be selectively exchanged and shared to each other in the social network SN. Thus, after a tag is built up by a person, others can share the tag without inputting repeatedly. In practice, the range of the social network SN can be a communication range of the protocol listed above, such as the range covered by one, a plurality of WiFi access points, or a base station.

In a practical application, the social network SN can be an internet-based social network. For example, when the number of the shared tags provided by the location-based network is too small or zero, users can communicate with bigger social networks SN, such as internet-based social networks SN, to get more shared tags. The so-called “location-base” refers to the location of a user and the adjacent range. It is notable that the social network SN can be a relation-based social network SN, a friendship-based social network, a coworker-based social network, or a community-based social network.

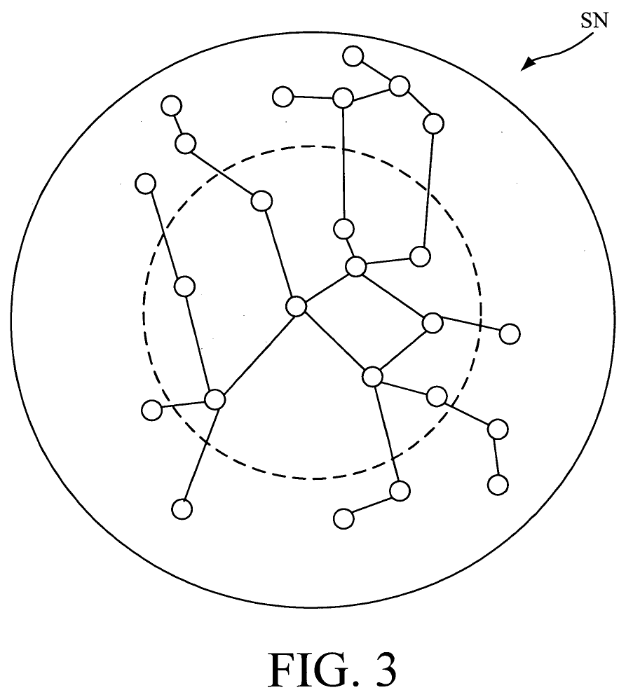

Please refer to FIG. 3. FIG. 3 is a schematic diagram illustrating the social network SN in FIG. 1 from nearest to farthest. In a practical application, the social network SN can be from nearest to farthest, that is, to find shared tags from a first layer social network SN organized by adjacent relationships. If the shared tags provided by the first layer social network SN are not enough, the social network SN can be expanded, such as to relations, coworkers, friends, or communities, so as to find shared tags from the expanded social network SN, as shown in FIG. 3.

In an embodiment, after receiving the shared tag through the communication module 12, and the processing module 14 can determine whether the shared tag matches the set of initial data ID. If the result is positive, the shared tag can be set to be the applicable tag. For example, if the shared tag received by the processing module 14 is “museum” and the processing module 14 confirms that the user is rightly at a museum according to the location communication included in the set of initial data ID, the processing module 14 will determine that the shared tag matches the set of initial data ID and set the shared tag to be the applicable tag. In practice, the applicable tag either can be assigned to the digital content directly by the processing module 14, or can be displayed on a display module 20 of the electronic apparatus 1 for users to confirm whether the digital content can be assigned with the applicable tag.

In an embodiment, if the processing module 14 determines that the shared tag does not match the set of initial data ID, the processing module 14 can further generates an extended shared tag according to the shared tag, and generate the applicable tag according to the extended shared tag and the set of initial data ID. The processing module 14 can select (not shown) vocabularies from a database that have similar or same meanings or concepts, wherein the database can be embedded in the electronic apparatus 1 or the sever 3. For example, if a shared tag is “beauty” and the processing module 14 determine that the shared tag does not match the set of initial data ID, the processing module 14 can further generate an extended shared tag “loveliness” according to the shared tag “beauty” and generate, based on a tag choice mechanism, the applicable tag according to the extended shared tag and the set of initial data ID.

In practice, when the electronic apparatus 1 cannot communicate with the social network SN or the electronic apparatus 1 cannot find the social network SN, the processing module 14 still can generate, based on the tag choice mechanism, the applicable tag according to the set of initial data ID. For example, the tag choice mechanism can generate applicable tags such as “birthday”, “restaurant A”, “celebration”, or “dinner party” according to user's birthday from the set of initial data ID, according to user's location information (e.g., restaurant A) from the location information, and according to user's action event (e.g., press the shutter). In another word, the tag choice mechanism can make a determination by time, location information, or an action event.

In other words, the tag choice mechanism serves as a tag choice or a generation mechanism when the shared tag does not match the set of initial data ID or the electronic apparatus 1 cannot communicate with the social network SN. When the shared tag does not match the initial data ID, the tag choice mechanism generates at least one applicable tag according to the set of initial data ID stored in the storage module 10 and the extended shared tag. Then, users can make the choice and confirm whether the at least one applicable tag would be assigned to the digital content.

When the electronic apparatus 1 cannot communicate with the social network SN, the tag choice mechanism can generate at least one applicable tag according to the set of initial data ID stored in the storage module 10. Then, users can make the choice and confirm whether the at least one applicable tag would be assigned to the digital content.

Thus, users can conveniently utilize the at least one applicable tag which is automatically generated and selectively assign the applicable tag to the digital content without inputting tags by themselves. Therefore, after being generated by someone, the tag can be shared to others with the tag shared mechanism depicted above via the social network without repetitively inputting by others, which it is convenient to all users.

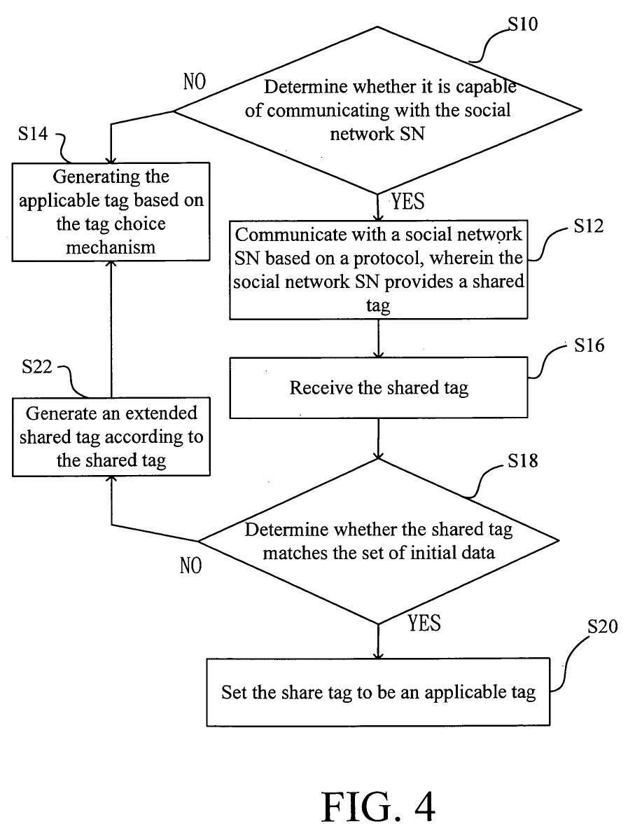

Please refer to FIG. 4 along with FIG. 1. FIG. 4 is a flow chart diagram showing a tag generation method according to an embodiment of the invention. In the embodiment, the tag generation method can be performed to generate an applicable tag related to a digital content, wherein a set of initial data ID related to the digital content is provided in advance. In a practical application, the tag generation method can be applied, but not limited to, the electronic apparatus 1 shown in FIG. 1.

As shown in FIG. 4, the tag generation method firstly includes step S10: determining whether it is capable of communicating with the social network SN. If the result of step S10 is positive, the tag generation method next includes step S12: communicating with a social network SN based on a protocol, wherein the social network SN provides a shared tag. If the result of step S10 is negative, the tag generation method then includes step S14: generating the applicable tag based on a tag choice mechanism.

After finishing step S12, the tag generation method includes step S16: receiving the shared tag. After that, the tag generation method includes step S18: determining whether the shared tag matches the set of initial data ID. If the result of step S18 is positive, the tag generation method includes step S20: setting the shared tag to be an applicable tag.

If the result of step S18 is negative, the tag generation method includes S22: generating an extended shared tag according to the shared tag. After finishing step S22, the tag generation method includes step S14, generating the applicable tag based on the tag choice mechanism.

Thereby, users can conveniently utilize the at least one applicable tag which is automatically generated and selectively assign the applicable tag to the digital content without inputting tags by themselves. The contents and examples related to the initial data, the social network, the protocol, and the tag choice mechanism have been described previously, so they will not be described in detail again here.

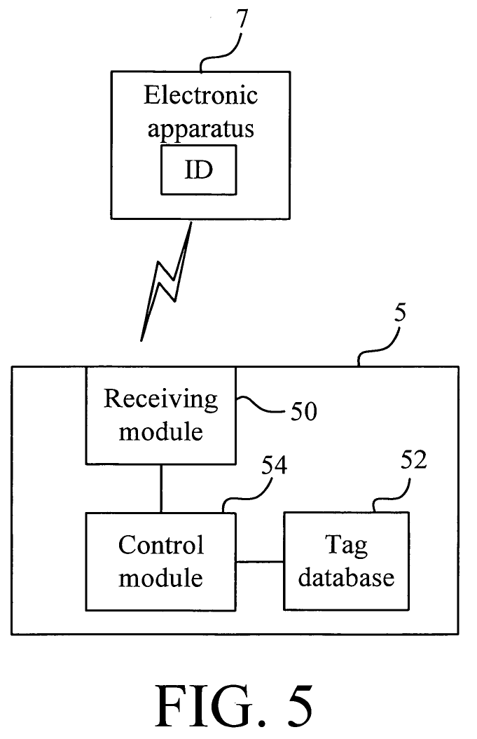

Please refer to FIG. 5. FIG. 5 is a schematic diagram illustrating a tag generation system 5 according to an embodiment of the invention. In the embodiment, the tag generation system 5 can be used to generate an applicable tag related to a digital content. In a practical application, the tag generation system 5 can be performed as, but not limited to, a server.

As shown in FIG. 5, the tag generation system 5 includes a receiving module 50, a tag database 52, and a control module 54. In the embodiment, the receiving module 50 can be used for receiving a set of initial data ID related to the digital content. The control module 54, respectively coupled to the receiving module 50 and the tag database 52, can be used for generating the applicable tag according to the set of initial data ID and the tag database 52.

In an embodiment, the receiving module 50 can communicate with an electronic apparatus 7 and receive the set of initial data ID from the electronic apparatus 7. In the practical application, the digital content is the digital content which the electronic apparatus 7 generated. In other words, after the electronic apparatus 7 generate the digital content, the set of initial data ID related to the digital content can be transmitted to the tag generation system 5 to generate the applicable tag related to the digital content.

In an embodiment, the control module 54 can retrieve a candidate tag from the tag database 52 according to the set of initial data ID and determining whether the candidate tag matches the set of initial data ID according to the set of initial data ID. If the result is positive, the candidate tag will be set to be the applicable tag.

In a practical application, the tag database 52 can be a data base which saves many tags, wherein the tags include at least one shared tag provided by the social network. In other words, the tag generation system 5 can exchange or swap shared tags with other people through the internet and save the shared tags into the tag database 52. In practice, the tag database 52 can be respectively built up for each user or a group of users, and share data through the internet. In practice, the control module 54 can retrieve, based on SQL database with the algorithm of artificial intelligence, the candidate tag from the tag database 52 according to the set of initial data ID.

In an embodiment, if the control module 54 determines that the candidate tag does not match the set of initial data ID, the control module 54 can further generate, based on an adaptive tag choice mechanism, the applicable tag according to the set of initial data ID. For example, the control module 54 can learn that the user is male and single, and loves western-style food and lives in Taipei. When the user celebrates his birthday with friend B and friend C at certain restaurant in Taipei and presses the shutter of Nikon D100 digital camera, the mechanism can automatically generate, according to the above initial data, applicable tags such as “birthday”, “restaurant”, “friend B”, “friend C”, “western-style food”, “Taipei”, “Nikon D100”, etc. In practice, the adaptive tag choice mechanism even can adaptively learn and analyze according to the habits that users will choose a tag, so as to generate a more suitable applicable tag to the users.

Thus, users can connect the electronic apparatus 7 to the tag generation system 5 to derive applicable tags from the tag generation system 5. If the applicable tag is suitable for the digital content, a user can assign the applicable tag to the digital content. In a practical application, the electronic apparatus 7 can be the same as the electronic apparatus 1 shown in FIG. 1, and the electronic apparatus 7 can determine whether to generate the applicable tags by itself or to generate the applicable tags with the tag generation system 5 according to the contents of the set of initial data ID. The contents and examples related to the initial data and the social network have been described previously, so they will not be described in detail again here.

Compared with the prior art, the invention provides the electronic apparatus, the tag generation method, and the tag generation system which is capable of automatically generating tags. The electronic apparatus, the tag generation method, and the tag generation system automatically generate an applicable tag related to a digital content by a shared tag and a set of initial data provided by a social network. Thereby, users can selectively assign the applicable tags, which are automatically generated, to the digital content without inputting the tags by themselves. Additional, it can share with other people to use, through the establishment of the tag by one person, by the tag shared mechanism of the social network. It is convenient to user, without the needs to repeat action.

With the example and explanations above, the features and spirits of the invention will be hopefully well described. Those skilled in the art will readily observe that numerous modifications and alterations of the device may be made while retaining the features and spirit of the invention. Accordingly, the above disclosure should be construed as limited only by the metes and bounds of the appended claims

What is claimed is:

1. An electronic apparatus, capable of automatically generating tags, for generating an applicable tag related to a digital content, the electronic apparatus comprising:
a storage module, for storing a set of initial data related to the digital content;
a communication module, for communicating with a social network based on a protocol, wherein the social network provides a shared tag; and
a processing module, coupled to the storage module and the communication module, for receiving the shared tag via the communication module and generating the applicable tag according to the set of initial data and the shared tag.

2. The electronic apparatus of claim 1, wherein the processing module generates the applicable tag by determine whether the shared tag matches the set of initial data, if YES, the shared tag will be set to be the applicable tag.

3. The electronic apparatus of claim 1, wherein the processing module generates the applicable tag according to an extended shared tag, generated according to the shared tag, and the set of initial data.

4. The electronic apparatus of claim 1, wherein the protocol is one selected from a group consisting of Bluetooth protocol, Zigbee protocol, WiFi protocol, IEEE 802.15.4 protocol, IEEE 802.11 series protocols, and RFID protocol.

5. The electronic apparatus of claim 1, wherein the social network is a location-based social network.

6. The electronic apparatus of claim 1, wherein the range of the social network is a communication range of the protocol.

7. The electronic apparatus of claim 1, the social network is an Internet-based social network.

8. The electronic apparatus of claim 1, wherein the set of initial data comprises at least one selected from a group consisting of a user preference, device information, location information, date information, time information, and an action event.

9. A tag generating method for generating an applicable tag related to a digital content, a set of initial data related to the digital content which is provided in advance, the tag generating method comprising the steps of:
communicating with a social network based on a protocol, wherein the social network provides a shared tag;
receiving the shared tag; and
generating the applicable tag according to the set of initial data and the shared tag.

10. The tag generating method of claim 9, wherein the step of generating the applicable tag is performed by determining whether the shared tag matches the set of initial data, if YES, the shared tag will be set as the applicable tag.

11. The tag generating method of claim 9, wherein the step of generating the applicable tag is performed according to an extended shared tag, generated according to the shared tag, and the set of initial data.

12. The tag generating method of claim 9, wherein the protocol is one selected from a group consisting of Bluetooth protocol, Zigbee protocol, WiFi protocol, IEEE 802.15.4 protocol, IEEE 802.11 series protocols, and RFID protocol.

13. The tag generating method of claim 9, wherein the social network is a location-based social network.

14. The tag generating method of claim 9, wherein the range of the social network is a communication range of the protocol.

15. The tag generating method of claim 9, the social network is an Internet-based social network.

16. The tag generating method of claim 9, wherein the set of initial data comprises at least one selected from a group consisting of a user preference, device information, location information, date information, time information, and an action event.

17. A tag generation system for generating an applicable tag related to a digital content, the tag generation system comprising:
a receiving module for receiving a set of initial data related to the digital content;
a tag database; and
a control module, coupled to the receiving module and the tag database, for generating the applicable tag according to the set of initial data and the tag database.

18. The tag generation system of claim 17, wherein the control module generates the applicable tag by retrieving a candidate tag from the tag database and determining whether the candidate tag matches the set of initial data, if YES, the candidate tag will be set as the applicable tag.

19. The tag generation system of claim 17, wherein the control module generates the applicable based on an adaptive tag choice mechanism and the set of initial data.

20. The tag generation system of claim 17, wherein the tag database comprises at least one shared tag provided by a social network.
